(19) United States
(12) Patent Application Publication
(10) Pub. No.: US 2018/0045372 A1
(43) Pub. Date: Feb. 15, 2018

(54) STATION FOR DISPENSING NATURAL GAS

(71) Applicant: Liquimet S.p.A., Treviso (IT)

(72) Inventors: Antonio NICOTRA, Luxembourg (LU); Erich Zanata, Treviso (IT)

(21) Appl. No.: 15/249,418

(22) Filed: Aug. 28, 2016

(30) Foreign Application Priority Data
Aug. 10, 2016 (IT) 102016000084499

(51) Int. Cl. F17C 13/02; F17C 5/02; F17C 5/06

(52) U.S. Cl. CPC F17C 13/025; F17C 5/06; F17C 5/02; F17C 2221/033; F17C 2227/0135; F17C 2265/065

(57) ABSTRACT

Station for dispensing natural gas, which comprises a source of natural gas (2) in the form of compressed gas or in the form of cooled liquid, a dispensing column (dispenser) (3) of such natural gas and feed means (4), which are hydraulically connected to the source of natural gas (2) and to the dispenser (3) in order to send the natural gas from the source to the latter. The dispenser (3) comprises at least one suction hood (100), positioned above the ground level, provided with a suction opening (101), susceptible of collecting natural gas dispersed in the environment, and with at least one expulsion opening (102) for evacuating the collected gas safely. The relevant engagement seat (30) of the gas dispensing head (5) is arranged below the suction opening (101) of the hood (100). The latter is exposed to an air flow, forced or natural, which crosses the relevant mechanical and/or electrical components controlling the gas flow to the heads (5), so as to safely evacuate possible leaks thereof.

### FIELD OF APPLICATION

The present invention concerns a station for dispensing natural gas, according to the preamble of the main independent claim.

The present station is intended to be advantageously employed for the dispensing of natural gas both in compressed gaseous form (CNG) and in liquid form (LNG) in the automotive service stations.

Therefore, the station, object of the present invention, falls within the industrial field of energy distribution for vehicles and in particular within the road service refueling stations.

### STATE OF THE ART

Service stations for dispensing liquid or gaseous fuels, well-known to be dislocated along roads, conventionally consist of a storage tank connected to dispensers associated with the dispensing heads for introducing the fuel into the tanks of the vehicles.

The storage tanks generally consist of an underground tank in case of conventional fuels such as gasoline or diesel, or an above ground tank in the case of liquid-state gaseous fuels.

As known, besides the more conventional dispensers of liquid fuels such as gasoline and diesel, gaseous-form compressed natural gas CNG (Compressed Natural Gas) dispensers or liquid-form petroleum gas LPG (Liquefied Petroleum Gas) dispensers are widespread. More recently, also cryogenic-liquid form natural gas LNG (Liquefied Natural Gas) dispensers are also becoming more widespread.

With respect to the liquid fuels, such as gasoline and diesel, gaseous fuels (CNG, LNG, LPG) offer reduced costs and less environmental impact due to the lower emissions of carbon dioxide, particulates, aromatic/cancerogenic derivatives, sulphur derivatives and nitrogenous derivatives, resulting from the relevant combustion processes.

More in detail, natural gas is a fuel both of fossil and renewable-biological origin (bio-gas) mainly composed of methane (CH4), or more precisely by a mixture of methane and much smaller quantities of volatile hydrocarbons and nitrogen.

The natural gas employed in gaseous form in the automotive service stations (in English CNG) is stored in normally cylindrical or spherical tanks at pressures on the order of 200-250 bar, in order to compress the volume by 200-250 times with respect to what it would occupy at normal atmospheric pressure. Gaseous natural gas is therefore well-known to be usually employed in the internal combustion spark-engines (gasoline/CNG) bi-fuel cars.

The natural gas employed in liquid form in the automotive service stations (in English LNG), in particular for heavy road haulage, and which only more recently has started to be widespread, is transported and stored at cryogenic temperatures (approximately −161° C., at ambient pressure). Such liquid form allows reducing the specific volume by approximately 600 times compared to the gaseous form at atmospheric pressure and hence to a volume three times less than compressed gas CNG, allowing to store and transport considerable quantities of energy in considerably reduced spaces, comparable with the typical liquid fuels (diesel and gasoline).

Liquid natural gas LNG is obtained by cooling gaseous natural gas to the condensation point, which corresponds to approximately −161° C. at ambient pressure. For the delivery of LNG to the service stations, cryogenic tankers are used which normally load LNG at coastal terminals, fed by methane-tankers suitable for the cryogenic transport of the gas already in the liquid state.

A problem particularly felt by producers and users of fuel service stations regards both the safety during refueling with reference to fire risk of the fuel or vapors thereof, and the environmental protection in order to prevent diffusing toxic or in any case harmful gasses to the environment itself.

Generally, in the fuel service stations, and in particular road service stations for refueling motor vehicles, safety and environmental protection laws require that the vapor phase, constituted by a mix of air and fuel vapors, which exit from the tank of the motor vehicles during refueling, is not dispersed in the environment.

Such emission is mainly caused by the displacement due to the fuel introduced in the tank, which—by reducing the volume above the level in the tank—expels an equivalent volume of vapor phase.

Advantageously, in order to prevent such vapor emission into the environment, fuel dispensing heads are available with both fuel dispensing nozzles and suction nozzles.

Such known solution allows limiting the problem of emission of inflammable vapors of the fuel during refueling, however it produces no effect on possible release of fuel or vapors due to leaks, or due to a malfunctioning of the dispenser, or even only due to an error of the user or operator of the service area who carries out the refueling.

Conventional fuels such as gasoline and diesel employed in the service stations are heavier than air, in particular they are liquids and they flow towards the ground such that if there would be an accidental fuel leak at the dispenser, in particular during vehicle refueling operation, the fuel leaks would be conveyed into suitable draining channels. Also the LPG gas is heavier than air and its vapors hence flow towards the ground.

Therefore, safety measures for removing possible fuel leaks in the conventional refueling service stations are designed for liquids and vapors that are heavier than air.

On the contrary, the natural gas distributed in the automotive refueling service stations in gaseous form or in liquid form has a lower density than that of the air and consequently naturally tends to disperse upward if introduced into the environment at atmospheric pressure, for example due to a leak of the dispensing head or due to an incorrect maneuver of the user.

Therefore, safety and environmental devices for the evacuation of fuels introduced into the environment that are designed for more conventional fuels (downward dispersions) are not well suited for being employed in natural gas dispensing stations (upward dispersions).

### PRESENTATION OF THE INVENTION

In this situation, the main problem underlying the present invention is therefore that of overcoming the drawbacks of the abovementioned prior art, by providing a station for dispensing natural gas which is particularly safe for the user.

Another object of the present invention is to provide a station for dispensing natural gas which is structurally simple, inexpensive and entirely reliable in operation.

### BRIEF DESCRIPTION OF THE DRAWINGS

The technical characteristics of the invention, according to the aforesaid objects, can be clearly seen in the contents of the below-reported claims and the advantages thereof will be more evident from the following detailed description, made with reference to the enclosed drawings which represent a merely exemplifying and non-limiting embodiment of the invention, in which:

FIG. 1 shows a front schematic view of the station for dispensing natural gas, object of the present invention, represented in a portion thereof including multiple dispensers;

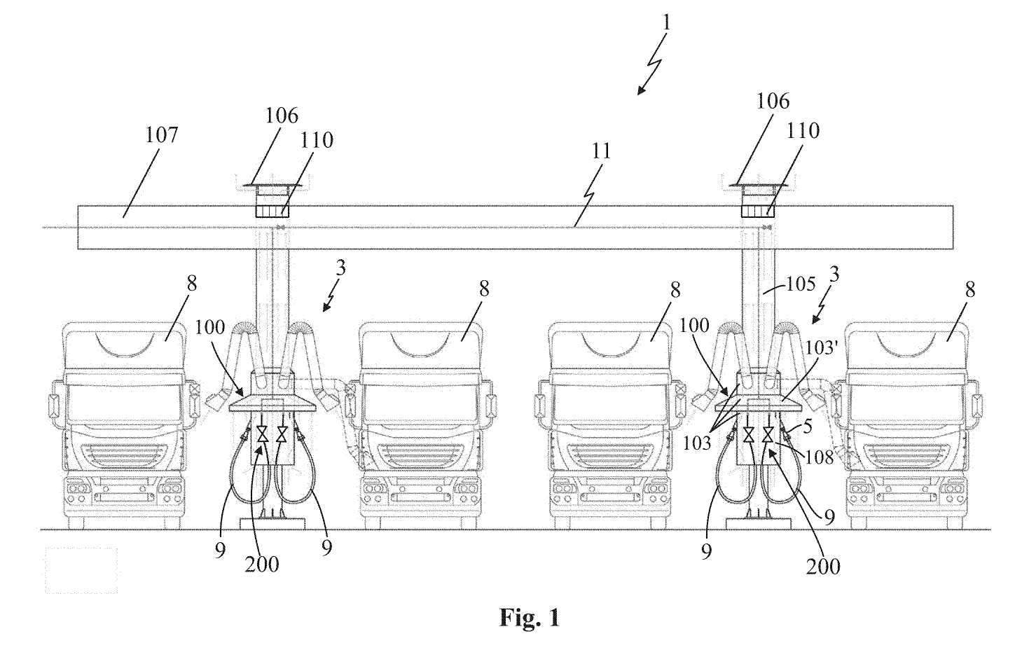

FIG. 2 shows a detail of the station of FIG. 1 relative to a single dispenser;

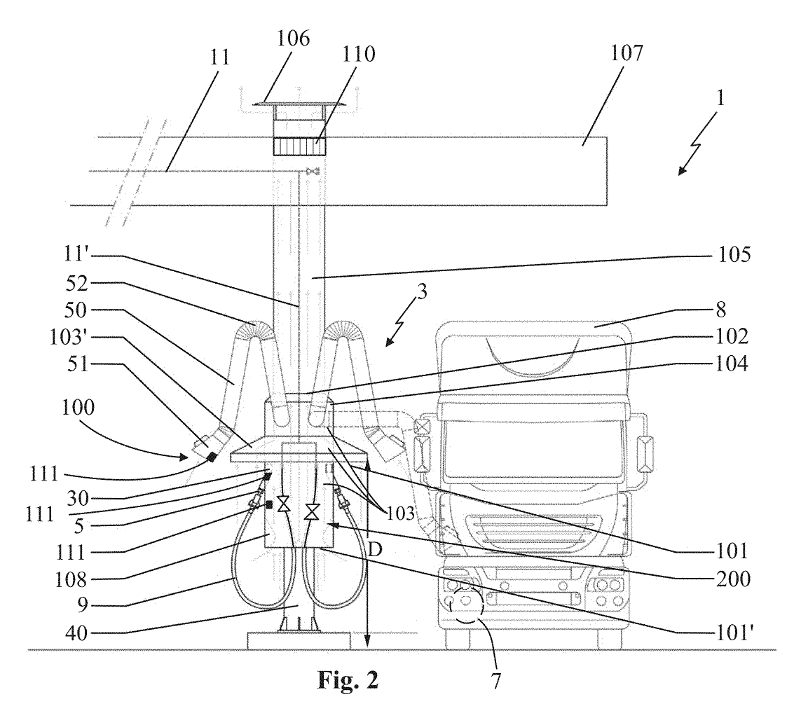

FIG. 3 shows the dispenser of FIG. 2 in a side view;

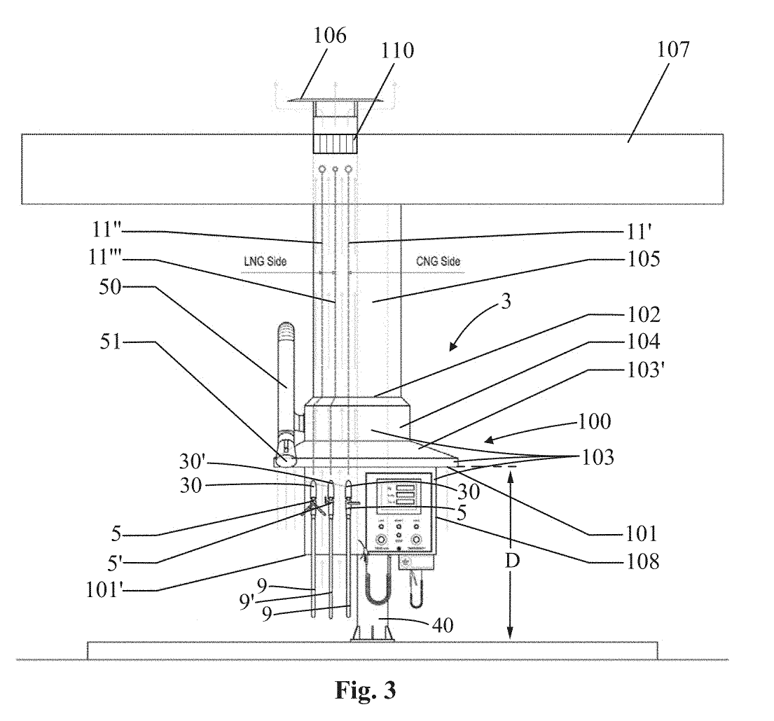

FIG. 4 schematically shows the entire station for dispensing natural gas, object of the present invention, with some parts removed in order to better show other parts.

### DETAILED DESCRIPTION

With reference to the enclosed drawings, reference number 1 overall indicates a station for dispensing natural gas, object of the present invention.

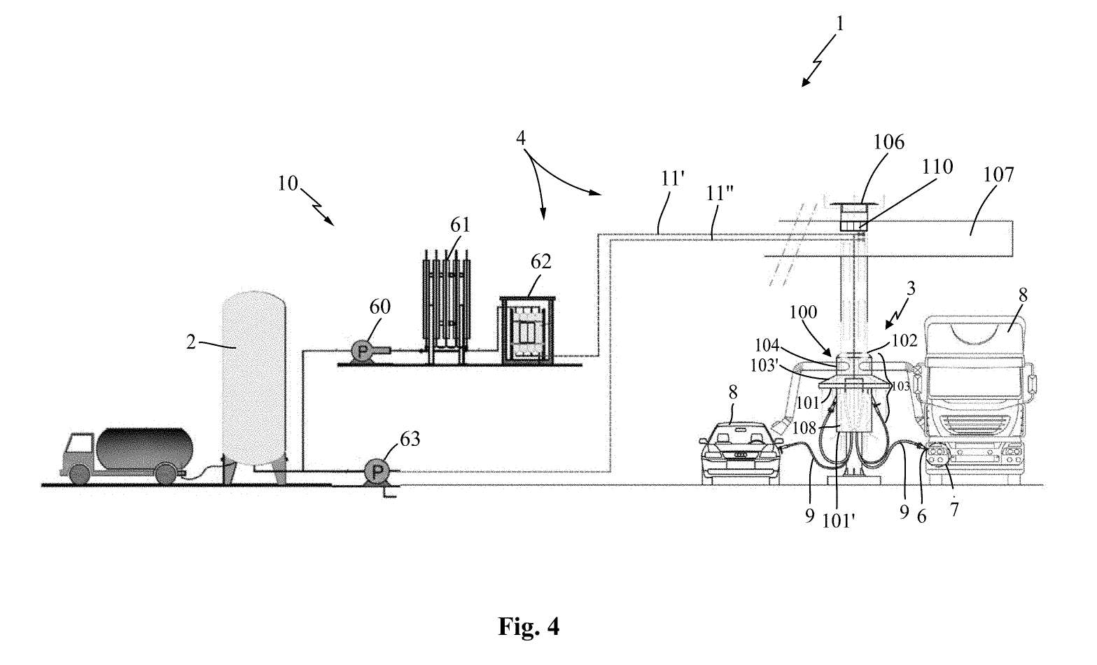

In accordance with the enclosed figures, the station 1 advantageously comprises a source of natural gas, which is constituted, in accordance with the embodiment of FIG. 4, by a storage tank 2 for natural gas in liquid form, and by a distribution network of gas in liquid form (LNG) and/or compressed gaseous form (CNG), also in accordance with an embodiment that is not specifically illustrated since it is well-known to the man skilled in the art.

The station 1 also comprises one or more dispensing columns (dispensers) 3, receiving the fuel by the feed means 4, and each provided with one or more dispensing heads 5. The latter are provided with a dispensing nozzle 6 susceptible of mechanical coupling to the tank 7 of the vehicle 8 to be refueled. The dispensing head 5 is also hydraulically connected by means of a hose 9 to the feed means 4 for a facilitated handling during refueling.

The feed means 4 comprise, in a per se known manner, a pump group 10 connected to the tank 2, in the case of operation with liquid gas illustrated in the embodiment of FIG. 4, or connected to the gas distribution network in the case of operation with compressed gas, in the case of the non-illustrated embodiment. The aforesaid feed means 4 also comprise at least one feed pipe 1, which connects the pump group 10 to the dispenser 3 in order to refuel it with the required flow of natural gas. In the dispenser 3, a meter device is provided (not illustrated) which measures the quantity of natural gas dispensed, before sending it to the hose 9 of the dispensing head 5.

Advantageously, in a known manner, the meter is connected to a pulse generator, which generates an electric pulse for each unit of natural gas dispensed, on the basis of which a logic control unit calculates and indicates the quantity dispensed and relative gas refueling price.

The station, object of the present invention, can only operate with natural gas in gaseous form (CNG) or only with natural gas in liquid form (LNG) or with natural gas provided in the automotive service stations in both gaseous and liquid forms.

In accordance with the embodiment illustrated in the enclosed figures, a station has been provided that operates for dispensing both natural gas in compressed form and for dispensing natural gas in liquid form.

For such purpose, the pump group 10, exemplified in FIG. 4, comprises for the CNG gas production branch: a high-pressure volumetric pump 60 (e.g. 300 bar), air vaporizers 61, which receive the liquid gas at high pressure from the volumetric pump and directs it towards a tank 62 advantageously obtained with a cylinder pack. The latter is then connected to the dispenser 3 by means of the feed pipe 11 advantageously comprising at least one final section constituted by a first aerial hose 11′ as specified hereinbelow.

The same pump group 10, exemplified in FIG. 4, comprises for the LNG production branch: an immersed centrifugal pump 63 (e.g. at 6 bar) which is connected to the dispenser 3 by means of its feed pipe 11, advantageously comprising at least one second aerial hose 11″ as specified hereinbelow.

The station 1 for dispensing natural gas according to the present invention can therefore provide for the simultaneous possibility of distribution of compressed natural gas and of liquid natural gas, which can advantageously share the dispenser 3.

Of course, without departing from the protective scope of the present patent, the station can as stated function for dispensing natural gas even only in gaseous form (CNG) or even only in liquid form (LNG).

In the case of dispensing only CNG, the pump group 10 may comprise, instead of the components of the example shown in FIG. 4, a high-pressure compressor, well known to the experts, receiving the natural gas directly from the gas distribution network, compressing it to e.g. at 200-250 bar and directly feeding the abovementioned cylinder pack tank 62.

The aforesaid characteristics, briefly mentioned above, are not illustrated and described in detail since they are well-known to the man skilled in the art and are to be deemed common to a normal dispensing station of natural gas in compressed gaseous form or in cooled liquid form.

According to the idea underlying the present invention, each dispenser 3 comprises at least one suction hood 100 for suctioning possible leaks of gas or vapors of natural gas that are dispersed in proximity thereto, e.g. due to a failure, a leak or simply due to an incorrect maneuver of the operator who is carrying out the refueling.

The hood 100 is provided with at least one suction opening 101 preferably widened, susceptible of conveying natural gas dispersed in the environment, and with at least one expulsion opening 102, preferably narrowed, arranged above the suction opening 101 for evacuating the gas collected from the same suction opening 101, advantageously safely through a stack 106 as in the following. Such two openings 101 and 102 are connected to each other through a connector body 103 of the hood 100.

Advantageously and in particular if the hood 100 operates with a natural suction of the gas without requiring forced suction means, the suction opening 101 is widened while the expulsion opening 102 is narrowed, i.e. with width smaller than that of the suction opening 102 to which it is connected by means of the connector body 103, which is narrowed from the suction opening 101 to the expulsion opening 102.

In accordance with such embodiment, the connector body 103 of the hood 100 comprises a portion with frustoconical shape 103′ (such shape can also be provided in the case of forced suction, specified hereinbelow), with circular or polygonal section that is tapered towards the expulsion opening 102. In accordance with the embodiment of the enclosed figures, the connector body 103 also comprises a substantially tubular portion 104 that extends the frustoconical portion 103′, up to the expulsion opening 102 of the hood 100. The tubular portion 104 is in turn preferably extended with an evacuation pipe 105 that terminates with a stack 106. More generally, the single hoods 100 associated with the single dispensers 3 can be connected to each other by a fumes expulsion network formed by pipes that comprise the single vertical evacuation pipes 105 and other horizontal connector pipes 107 intercepted by one or more stacks 106.

The stack 106 releases the air/gas mixture in the environment safely, high above the ground operational level and with gas/air ratio beyond the natural gas flammability range.

The dispenser 3 is for example supported by a column 40 fixed to the ground, and it is advantageously provided with a first engagement seat 30 susceptible of housing, in retention mode, but simultaneously in a removable manner, the dispensing head 5 when it is not employed for refueling the vehicle 8, in this case defining a rest position thereof.

More clearly, each dispensing head 5 is susceptible of being moved between a rest position, in which it is engaged in a first engagement seat 30 of the distribution pump 3, and an operative position in which it is connected to the tank 7 of the vehicle 8 for the refueling thereof.

Such first engagement seat 30 is housed below the suction opening 101 of the hood 100. The dispensing head 5 will be of cryogenic type in the case of dispensing of gas in liquid form and of high-pressure type in the case of dispensing of compressed gas in gaseous form; both types of heads are well-known to the man skilled in the art and for this reason are not described in detail herein.

Preferably, the station 1 comprises forced suction means 110 associated with the hood 100 in order to force a gas flow suctioned from the suction opening 101 to ascend towards the expulsion opening 102, in order to then be directed towards evacuation.

The hood 100, in the widest definition thereof, is extended due to its connector body 103 from the least one main suction opening 101 to the expulsion opening 102, and is then traversed by an air flow that is natural or forced.

The feed means 4 comprise mechanical and/or electrical interception members for controlling the flow of the gas, such as a flow meter or valves for intercepting the dispensing of the gas flow to the heads 5, which generally have been exemplified with one or more valves 200 in the enclosed figures and which are housed in the aforesaid connector body 103.

The passage of an air flow between the at least one main suction opening 101 and the expulsion opening 102 causes the aeration of the aforesaid interception members 200 contained in said connector body 103, and hence the evacuation of possible leaks provided therein. More clearly, the connector body 103 of the hood 100 that contains the interception members 200 allows air passage (whether this is a natural or forced passage) and is not a closed structure like the dispensers of the prior art. Consequently, in case of leaks, the latter are easily suctioned and dispersed into the atmosphere without pneumatically driven in order to minimize the risk that contact with inflammable gas may trigger fires or explosions.

Otherwise, an electric motor can in any case be provided that complies with current law regarding fire prevention.

Otherwise, in accordance with a different embodiment, the suction means 110 are only activated upon exceeding a (maximum) threshold value of the natural gas concentration detected by at least one gas detection sensor 111 arranged in communication with the same logic control unit. Such at least one sensor 111 can be mechanically associated with the dispenser 3 and/or with the dispensing head 5.

The gas detection sensor 111 can also or alternatively—once the exceeding of the gas concentration threshold value has been detected—determine through the logic control unit the driving of emission of a visual and/or acoustic alarm signal.

The abovementioned feed pipe 11 of the feed means 4, for refueling the dispenser 3 with the required flow of natural gas, is advantageously constituted by an aerial hose or at least provided with an aerial terminal section 11′, 11″ that is extended above the dispenser 3, feeding it from above. Such aerial hose has been indicated in figures with 11′, in the case of distribution of compressed gas and with 11″, in the case of distribution of gas in liquid form.

If the station 1 provides for the distribution of natural gas in liquid form, i.e. of distribution of natural gas jointly in gaseous form and also in liquid form, a vapor return pipe 11′″ is also provided which transports the latter, e.g. at 8 bar mean pressure, from the tank 7 of the vehicle 8 to the storage tank 2. Such return pipe 11′″ is advantageously constituted, like the aerial feed ducts 11′, 11″, by an aerial hose or it is at least provided with an aerial terminal section which is extended above the dispenser 3.

For such purpose, the dispenser 3 is also provided with an evacuation head 5′, which is connected to the end of a hose 9′ that forms the final section of the vapor return pipe 64.

A second engagement seat 30′ in the dispenser 3 is provided in order to house the evacuation head 5′ when it is not operatively employed during refueling of the vehicle 8.

The station can finally comprise suction ducts 50 connected to the hood 100 and capable of being manually handled in order to bring the suction mouth 51 thereof in proximity to the tank 7 of the vehicle 8 for the purpose of suction the eventual gaseous losses thereof. Such ducts 50 are for example constituted by a hose connected to the tubular portion 104 of the hood 100 and provided with a median elbow-like portion 52 that is corrugated in order to allow a facilitated movement between a suction position in proximity to the vehicle 8, in which the forced suction means 110 are automatically activated, and a retracted non-operative position, in which the forced suction means 110 are in turned-off condition. Such ducts 50 are advantageously only provided in the case of dispensing natural gas in liquid form and they can have, associated therewith, a gas detection sensor 111, of the above-described type, in order to activate the forced suction through the hood 100.

The device thus conceived therefore attains the pre-established goal of improving the refueling safety in case of accidental losses of gas.

Obviously, in the practical executions thereof, it can also assume shapes and configurations that are different from those illustrated above, without departing from the present protective scope.

In addition, all details can be substituted with technically equivalent elements and the sizes, shapes and materials used can be of any type in accordance with the requirements.

1. Station for dispensing natural gas, which comprises:
at least one source of natural gas (2) in the form of compressed gas or in the form of cooled liquid;
at least one dispenser (3) for said natural gas;
feed means (4), which are hydraulically connected to said source of natural gas (2) and to said dispenser (3) in order to send said natural gas to the latter;
said dispenser (3) being provided with at least one dispensing head (5) hydraulically connected to said feed means (4) by means of a hose susceptible of being moved between a rest position, in which it is engaged in a first engagement seat (30) of said dispenser (3), and an operative position in which it is connected to the tank (7) of a vehicle (8) for the refueling thereof;
characterized in that said dispenser (3) comprises at least one suction hood (100), raised from the ground, provided with a suction opening (101), susceptible of collecting natural gas dispersed in the environment, and with at least one expulsion opening (102) for evacuating the collected gas; the first engagement seat (30) of said dispenser (3) being arranged below the suction opening (101) of said hood (100).

2. Station for dispensing natural gas according to claim 1, characterized in that it comprises forced suction means (110) associated with said hood (100) in order to force a gas flow sucked from said suction opening (101) towards said expulsion opening (102).

3. Station for dispensing natural gas according to claim 1, characterized in that the suction opening (101) of said hood (100) has greater size than the expulsion opening (102) of said hood, an air flow with natural circulation traversing said hood from the suction opening (101) to the expulsion opening (102) of said hood (100).

4. Station for dispensing natural gas according to claim 1, characterized in that said feed means (4) comprise at least one feed pipe (11) which connects said dispenser (3) to said source of natural gas (2) and is provided with at least one aerial non-underground terminal section (11′, 11″) which is extended above said dispenser (3), feeding it from above.

5. Station for dispensing natural gas according to claim 1, characterized in that it comprises a gas detection sensor (111) in communication with a logic control unit, mechanically associated with said dispenser (3) and/or with said dispensing head (5), and susceptible of detecting a percentage of natural gas greater than a pre-established threshold value; said logic control unit being susceptible of driving said forced suction means (110) when said threshold value is exceeded.

6. Station for dispensing natural gas according to claim 1, characterized in that it comprises a gas detection sensor (111) in communication with a logic control unit, mechanically associated with said dispenser (3) and/or with said dispensing head (5), and susceptible of detecting a percentage of natural gas greater than a pre-established threshold value; said logic control unit being susceptible of driving the emission of a visual and/or acoustic alarm signal when said threshold value is exceeded.

7. Station for dispensing natural gas according to claim 1, characterized in that said hood comprises at least one connector body (103), which connects said at least one suction opening (101) to said expulsion opening (102); said feed means (4) comprising mechanical and/or electrical interception members (200) for controlling the flow of the gas to said dispensing heads (5), housed in said connector body (103); the air flow of said hood (100) between said at least one main suction opening (101) and said expulsion opening (102) determining an aeration of said interception members (200) for the evacuation of possible leaks thereof.

8. Station for dispensing natural gas according to claim 1, characterized in that said source of natural gas comprises a storage tank (2) for natural gas in liquid form; said feed means (4) comprising a pump group (10) connected to said storage tank (2) and to said dispenser (3) by means of a first aerial feed pipe (11′) in order to refuel said dispenser (3) with the required flow of natural gas in compressed gaseous form and with a second aerial feed pipe (11″) in order to refuel said dispenser (3) with the required flow of natural gas in liquid form; an aerial vapor return pipe (11′″) being provided for connecting the tank (7) of said vehicle (8) to said storage tank (2), during the refueling of said vehicle.
